(19) United States
(12) Patent Application Publication
(10) Pub. No.: US 2021/0391683 A1
(43) Pub. Date: Dec. 16, 2021

(54) LASER DEVICE

(71) Applicant: Mitsubishi Electric Corporation, Tokyo (JP)

(72) Inventors: Yuzuru TADOKORO, Tokyo (JP); Junichi NISHIMAE, Tokyo (JP); Tatsuya YAMAMOTO, Tokyo (JP)

(73) Assignee: Mitsubishi Electric Corporation, Tokyo (JP)

(21) Appl. No.: 17/281,579

(22) PCT Filed: Oct. 10, 2018
(86) PCT No.: PCT/JP2018/037773

§ 371 Date: Mar. 31, 2021

(51) Int. Cl. H01S 3/123; H01S 3/11

(52) U.S. Cl. CPC H01S 3/123; H01S 3/2232; H01S 3/1103

(57) ABSTRACT

A laser device includes: a first mirror and a second mirror that cause resonance of a plurality of beams having different wavelengths from one another; a diffraction grating that causes the beams that are incident from the first mirror with directions of beam central axes being different from one another to travel to the second mirror while aligning the beam central axes with one another, and causes the beams that are incident from the second mirror with the beam central axes being aligned with one another to travel to the first mirror while causing the directions of the beam central axes to be different from one another; and a housing unit housing a laser medium that is a medium through which the beams traveling between the first mirror and the diffraction grating pass, and has a discrete gain spectrum in which a peak occurs at each wavelength of the beams.

### FIELD

The present invention relates to a laser device that causes resonance of a plurality of beams having different wavelengths from one another.

### BACKGROUND

Patent Literature 1 discloses that, for a laser device that amplifies and outputs a beam having a plurality of wavelength components, an optical element causing a loss in the wavelength component with the maximum oscillation intensity is disposed in a resonator. The laser device of Patent Literature 1 can even out the output intensity of the wavelength components by promoting amplification of the wavelength components other than the wavelength component with the maximum oscillation intensity, and can achieve high efficiency and high output.

Patent Literature 2 discloses a laser device that outputs a plurality of beams by causing resonance of a plurality of beams having different wavelengths from one another between a diffraction grating and a mirror. The laser device of Patent Literature 2 causes the plurality of beams to travel between the diffraction grating and the mirror while the directions of beam central axes are different from one another.

### CITATION LIST

### Patent Literature

Patent Literature 1: Japanese Patent Application Laid-open No. 2006-135298

Patent Literature 2: Japanese Patent Application Laid-open No. S53-125795

### SUMMARY

### Technical Problem

The laser device of Patent Literature 1 described above has had a problem in that it is difficult to implement adjustment by the optical element so as to cause a loss in the wavelength component having the maximum oscillation intensity and not to cause a loss in the other wavelength components.

The laser device can output a beam having a plurality of wavelength components by coupling a plurality of beams with the directions of beam central axes being different from one another. However, the laser device of Patent Literature 2 described above does not include a configuration that enables coupling of the plurality of beams for output. The laser device is also required to improve the quality of the beam being output.

The present invention has been made in view of the above, and an object of the present invention is to provide a laser device that can couple and output a plurality of beams having different wavelengths from one another, and can achieve high efficiency, high output, and improvement of the quality of a beam.

### Solution to Problem

In order to solve the above problem and achieve the object, a laser device according to the present invention includes a first mirror and a second mirror that cause resonance of a plurality of beams having different wavelengths from one another. The laser device according to the present invention includes a diffraction grating that causes the plurality of beams that are incident from the first mirror with directions of beam central axes being different from one another to travel to the second mirror while aligning the beam central axes with one another, and causes the plurality of beams that are incident from the second mirror with the beam central axes being aligned with one another to travel to the first mirror while causing the directions of the beam central axes to be different from one another. The laser device according to the present invention includes a housing unit housing a laser medium that is a medium through which the plurality of beams traveling between the first mirror and the diffraction grating pass, and has a discrete gain spectrum in which a peak occurs at each wavelength of the plurality of beams.

### Advantageous Effects of Invention

The present invention can couple and output a plurality of beams having different wavelengths from one another, and can achieve high efficiency, high output, and improvement of the quality of a beam.

### BRIEF DESCRIPTION OF DRAWINGS

FIG. 1 is a diagram illustrating a schematic configuration of a laser device according to a first embodiment of the present invention.

FIG. 2 is a graph illustrating an example of a gain spectrum of a plurality of beams oscillated by the laser device illustrated in FIG. 1.

FIG. 3 is a set of diagrams for explaining the behavior of the plurality of beams oscillated by the laser device illustrated in FIG. 1.

FIG. 4 is a diagram illustrating a schematic configuration of a laser device according to a first variation of the first embodiment.

FIG. 5 is a diagram illustrating a schematic configuration of a laser device according to a second variation of the first embodiment.

FIG. 6 is a set of graphs for explaining equalization of the intensity of beams in the laser device illustrated in FIG. 5.

FIG. 7 is a diagram illustrating a schematic configuration of a laser device according to a third variation of the first embodiment.

FIG. 8 is a diagram illustrating a schematic configuration of a laser device according to a fourth variation of the first embodiment.

FIG. 9 is a diagram illustrating a schematic configuration of a laser device according to a fifth variation of the first embodiment.

FIG. 10 is a diagram illustrating a schematic configuration of a laser device according to a second embodiment of the present invention.

FIG. 11 is a diagram illustrating a first example of a configuration for improving coupling efficiency in the laser device illustrated in FIG. 10.

FIG. 12 is a diagram illustrating a second example of a configuration for improving the coupling efficiency in the laser device illustrated in FIG. 10.

FIG. 13 is a diagram illustrating a third example of a configuration for improving the coupling efficiency in the laser device illustrated in FIG. 10.

FIG. 14 is a diagram illustrating a fourth example of a configuration for improving the coupling efficiency in the laser device illustrated in FIG. 10.

FIG. 15 is a diagram illustrating a fifth example of a configuration for improving the coupling efficiency in the laser device illustrated in FIG. 10.

FIG. 16 is a diagram illustrating a schematic configuration of a laser device according to a third embodiment of the present invention.

FIG. 17 is a diagram illustrating a schematic configuration of a laser device according to a first variation of the third embodiment.

FIG. 18 is a diagram illustrating a schematic configuration of a laser device according to a second variation of the third embodiment.

FIG. 19 is a diagram explaining a configuration for improving the coupling efficiency in the laser device illustrated in FIG. 18.

FIG. 20 is a diagram illustrating a schematic configuration of a laser device according to a fourth embodiment of the present invention.

### DESCRIPTION OF EMBODIMENTS

A laser device according to embodiments of the present invention will now be described in detail with reference to the drawings. Note that the present invention is not limited to the embodiments.

### First Embodiment

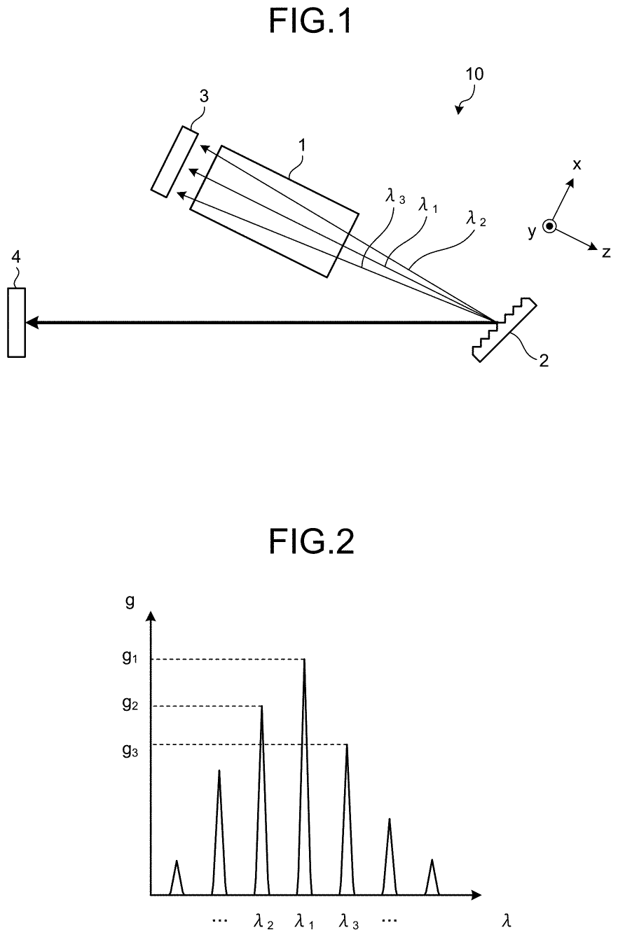

FIG. 1 is a diagram illustrating a schematic configuration of a laser device 10 according to a first embodiment of the present invention. The laser device 10 is a gas laser that oscillates a laser beam by exciting gas molecules by an electric discharge in a gas as a laser medium. The laser device 10 is a CO₂ laser that oscillates a laser using a laser medium containing carbon dioxide (CO₂).

The laser device 10 includes a first mirror 3 and a second mirror 4 that cause resonance of a plurality of beams having different wavelengths from one another. The first mirror 3 and the second mirror 4 form a resonator. The first mirror 3 reflects each of the plurality of beams. The second mirror 4 reflects a part of incident beams and transmits a part of the incident beams for the plurality of beams. The laser device 10 outputs a plurality of beams that have passed through the second mirror 4.

The laser device 10 includes a diffraction grating 2 that diffracts each of the plurality of beams. The diffraction grating 2 causes a plurality of beams, which are incident from the first mirror 3 with the directions of beam central axes being different from one another, to travel to the second mirror 4 while aligning the beam central axes with one another. The diffraction grating 2 also causes the plurality of beams, which are incident from the second mirror 4 with the beam central axes being aligned with one another, to travel to the first mirror while causing the directions of the beam central axes to be different from one another. Note that the beam central axis is an axis representing the center of a pencil of the beam. The beam travels in the direction of the beam central axis.

The laser device 10 includes a housing unit 1 that houses a laser medium. The laser medium is a medium through which the plurality of beams traveling between the first mirror 3 and the diffraction grating 2 pass. The laser medium has a discrete gain spectrum in which a peak appears at the wavelength of each of the plurality of beams.

The laser device 10 couples a plurality of beams by aligning the beam central axes of the plurality of beams. The laser device 10 outputs the plurality of beams in a state in which the beam central axes are aligned with one another.

FIG. 2 is a graph illustrating an example of a gain spectrum of a plurality of beams oscillated by the laser device 10 illustrated in FIG. 1. In the graph illustrated in FIG. 2, the vertical axis represents the gain, and the horizontal axis represents the wavelength. In the graph, “g” represents the gain, and “λ” represents the wavelength. The discrete gain spectrum is assumed to be a gain spectrum in which two or more peaks of the gain occur separately from each other in a wavelength band of the laser beam oscillated by the laser device 10 and there is a wavelength band between the peaks where the gain does not substantially contribute to laser oscillation. The laser medium has peaks of the gain at two or more specific wavelengths.

The gain spectrum illustrated in FIG. 2 has seven peaks at which the levels of the gain are different from one another. The peak at wavelength λ₁ is the peak with the gain of “g₁” that is the maximum in the wavelength band of the laser beam oscillated by the laser device 10. The peak at wavelength λ₂ is the peak with the gain of “g₂” that is the largest gain next to “g₁”. The peak at wavelength λ₃ is the peak with the gain of “g₃” that is the largest gain next to “g₂”. The space between the peaks in the graph indicates that the wavelength band between the peaks does not substantially contribute to laser oscillation. Note that the gain spectrum may have any number of peaks as long as it is plural.

With the laser medium having the discrete gain spectrum, the laser device 10 illustrated in FIG. 1 oscillates a plurality of laser beams having different peak wavelengths from one another. Note that FIG. 2 illustrates three beams having the wavelengths λ₁, λ₂, and λ₃, respectively.

In FIG. 1, an x-axis, a y-axis, and a z-axis are set as three axes perpendicular to one another. The optical axis of an optical system included in the laser device 10 is folded back at the diffraction grating 2. The z-axis represents the optical axis between the diffraction grating 2 and the first mirror 3. The first mirror 3 and the diffraction grating 2 are disposed on the z-axis. The second mirror 4 is disposed on the optical axis that is folded back at the diffraction grating 2 from the z-axis.

In the housing unit 1, a plurality of beams pass through different positions in a three-dimensional space represented by the x-axis, y-axis, and z-axis. In the housing unit 1, the beam central axes of the three beams illustrated in FIG. 1 have different inclinations with respect to the z-axis in a plane parallel to the x-axis and the z-axis, and do not intersect one another. The plurality of beams are simultaneously amplified by the laser medium at different positions.

The diffraction grating 2 illustrated in FIG. 1 is a reflective diffraction grating that reflects incident light to produce diffracted light. A regularly spaced grid pattern is formed on a reflecting surface of the diffraction grating 2. The diffraction grating 2 has a wavelength characteristic of reflecting light incident on the diffraction grating 2 in a direction that is different for each wavelength. Such a wavelength characteristic allows the diffraction grating 2 to reflect the plurality of beams incident from the second mirror 4 in different directions. As a result, the diffraction grating 2 causes the plurality of beams, which are incident from the second mirror 4 with the beam central axes being aligned with one another, to travel to the first mirror 3 while causing the directions of the beam central axes to be different from one another. The directions of travel of the plurality of beams from the diffraction grating 2 toward the first mirror 3 are dispersed, whereby the plurality of beams pass through different positions in the laser medium.

Moreover, the diffraction grating 2 having the above wavelength characteristic reflects a plurality of light beams, which are incident on the diffraction grating 2 at different angles of incidence, in the same direction. The diffraction grating 2 reflects each of the plurality of beams incident from the first mirror 3 after passing through the laser medium in the same direction. As a result, the diffraction grating 2 causes the plurality of beams, which are incident from the first mirror 3 with the directions of beam central axes being different from one another, to travel to the second mirror 4 while aligning the beam central axes with one another. Note that the diffraction grating 2 may be a transmission diffraction grating that transmits incident light to produce diffracted light.

The diffraction efficiency of the diffraction grating 2 changes depending on a polarization state. The laser device 10 can achieve high efficiency and high output by matching polarization that can achieve high diffraction efficiency in the diffraction grating 2 with polarization that causes less loss in the resonator. For example, when the first mirror 3 has a reflection characteristic in which a reflectance changes depending on polarization, the laser device 10 can reduce loss of light in the resonator and achieve high efficiency and high output by using the first mirror 3 that can achieve a high reflectance with respect to polarization common to polarization that allows the diffraction grating 2 to achieve high diffraction efficiency.

The diffraction grating 2 may be a blazed diffraction grating that can obtain the maximum diffraction efficiency for diffracted light of a specific order. When light of a wavelength called a blaze wavelength is incident on the blazed diffraction grating, the blazed diffraction grating concentrates light intensity on the diffracted light of a specific order and at the same time lowers light intensity of the diffracted light of the other orders. The laser device 10 can achieve high efficiency and high output by matching any one of the wavelengths of the plurality of beams with the blaze wavelength and setting the orientation of the diffraction grating 2 so as to enable oscillation of a beam that is the diffracted light of a specific order.

The first mirror 3 is a mirror installed at one end of two ends of the resonator, the one end corresponding to a side on which the laser medium is provided. The first mirror 3 has a reflectance that can implement the function of the resonator. For example, a coating with a high reflectance of 99% or higher is applied to the reflecting surface of the first mirror 3. The first mirror 3 reflects a plurality of beams dispersed from one another by the diffraction grating 2 in directions along corresponding beam central axes.

The second mirror 4 is a mirror installed at another end of the two ends of the resonator, the other end corresponding to a side opposite to the side on which the laser medium is provided. The second mirror 4 is a partially reflective mirror that reflects a part of a coupled beam, which is a plurality of beams with the beam central axes superimposed by the diffraction grating 2, in a direction along the beam central axis and transmits a part of the coupled beam. A coating with a reflectance of 50% to 95%, for example, is applied to the reflecting surface of the second mirror 4. Moreover, the laser device 10 can reduce the loss of light in the resonator by selecting a material that can achieve low loss for the wavelength of each beam oscillated as the material of a base material forming the second mirror 4.

The reflecting surface of the first mirror 3 and the reflecting surface of the second mirror 4 may each be any of a flat surface, a concave surface, and a convex surface. As the concave surface and the convex surface, various curved surfaces such as a spherical surface, an aspherical surface, a cylindrical surface, or a toroidal surface may be used as appropriate.

Next, the behavior of a beam in the laser device 10 will be described. The grid pattern of the diffraction grating 2, the position where the diffraction grating 2 is disposed, and the orientation of the diffraction grating 2 are set such that a plurality of beams are dispersed between the diffraction grating 2 and the first mirror 3 and are coupled between the diffraction grating 2 and the second mirror 4. The plurality of beams repeat being dispersed and coupled by the diffraction grating 2 while reciprocating between the first mirror 3 and the second mirror 4. While reciprocating in the resonator, the plurality of beams are amplified by repeatedly passing through the laser medium. A part of the beams amplified in the resonator transmits through the second mirror 4 and is emitted from the resonator in a direction along the beam central axis of each beam. The laser device 10 outputs the coupled beam that is the plurality of beams emitted from the resonator.

The laser device 10 according to the first embodiment disperses the plurality of beams by the diffraction grating 2 and thus simultaneously amplifies the plurality of beams by the laser medium at different positions in the housing unit 1. The laser device 10 also couples the plurality of beams by the diffraction grating 2 and outputs the coupled beam. The laser output from the laser device 10 is a sum of the outputs of the beams having the plurality of wavelengths. By oscillating the plurality of beams having the different wavelengths from one another, the laser device 10 can obtain the laser output higher than when oscillating only a beam having one wavelength.

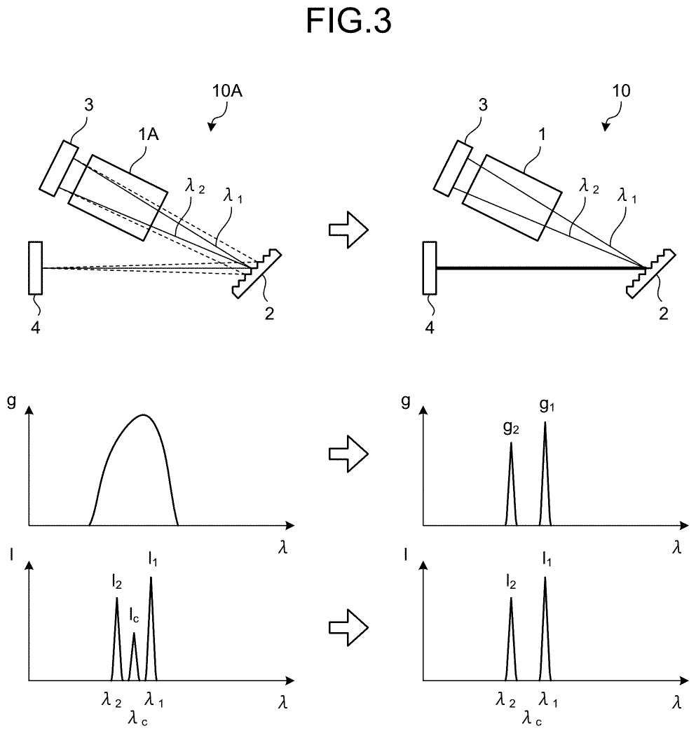

Next, an advantage of the laser medium having the discrete gain spectrum will be described. FIG. 3 is a set of diagrams for explaining the behavior of the plurality of beams oscillated by the laser device 10 illustrated in FIG. 1. FIG. 3 illustrates the laser device 10 according to the first embodiment and a laser device 10A according to a comparative example of the first embodiment. A laser medium having a continuous gain spectrum is housed in a housing unit 1A of the laser device 10A. FIG. 3 illustrates a gain spectrum representing a relationship between the wavelength “λ” and the gain “g” and an intensity spectrum representing a relationship between the wavelength “λ” and the beam intensity “I” for each of the laser devices 10 and 10A. FIG. 3 illustrates the beams having the wavelengths λ₁ and λ₂ that are two of the plurality of beams oscillated by the laser devices 10 and 10A.

The continuous gain spectrum is defined as a gain spectrum in a state where, in a wavelength band of the laser beam oscillated by the laser device 10, the gain in the wavelength band can contribute to oscillation of the laser beam in the wavelength band. The continuous gain spectrum is, for example, a gain spectrum in which the peak of the gain forms one peak in the wavelength band. When a beam passes through the laser medium having the continuous gain spectrum, a beam that does not contribute to dispersion and coupling is oscillated in the laser medium in addition to the plurality of beams repeatedly dispersed and coupled by the diffraction grating 2. This phenomenon is called cross-talk oscillation. In FIG. 3, a beam having a wavelength λ_{c} is one beam generated by the cross-talk oscillation, and is generated due to the gain at the wavelength λ_{c} between the wavelength λ₁ and the wavelength λ₂.

In FIG. 3, the beam having the wavelength λ_{c} propagating in the laser device 10A is indicated by a broken line. Outside the resonator, a deviation occurs between the beam central axis of the beam having the wavelength λ_{c} and the beam central axes of the plurality of beams. Thus, the beam generated by the cross-talk oscillation can be a factor for reducing the quality of the laser beam oscillated from the laser device 10A. Moreover, the output of the laser device 10A decreases as the number of beams generated by the cross-talk oscillation increases.

In the laser device 10 according to the first embodiment, a wavelength band between the peaks of the gain spectrum is a wavelength band that does not contribute to laser oscillation, and there is no gain at the wavelength λ_{c} between the wavelength λ₁ and the wavelength λ₂. The laser device 10 can prevent the cross-talk oscillation because the gain spectrum of the laser medium is the discrete gain spectrum. As a result, the laser device 10 can improve the beam quality and the output. The laser device 10 can thus couple and output the plurality of beams having different wavelengths from one another, and can achieve high efficiency, high output, and improvement of the beam quality.

The laser medium need only be one that contains CO₂ and may be a mixed gas containing CO₂ and another gas. Here, the mixed gas containing CO₂ and another gas is referred to as a CO₂ laser gas. The CO₂ laser gas may contain nitrogen (N₂), helium (He), carbon monoxide (CO), hydrogen (H₂), xenon (Xe), oxygen (O₂), or the like in addition to CO₂. When the CO₂ laser gas has a low pressure, for example, a gas pressure lower than about 100 Torr, the laser medium being the CO₂ laser gas has a discrete gain spectrum.

Assuming that a plurality of beams having different wavelengths from one another are superimposed in the laser medium, the laser oscillations of the beams compete with one another in the laser medium so that only the beam having the wavelength with the maximum gain is selectively oscillated. In the first embodiment, the laser medium has the discrete gain spectrum so that the laser device 10 oscillates a plurality of beams having wavelengths corresponding to the peaks of the gain spectrum. When the laser medium is the CO₂ laser gas, the laser device 10 oscillates beams referred to as P (20), P (18), and P (22) having wavelengths of 10.59 μm, 10.57 μm, and 10.61 μm, respectively. Note that the laser device 10 may oscillate a beam other than P (20), P (18), and P (22).

In the laser device 10, it is sufficient if the plurality of beams are dispersed in the laser medium to an extent that does not result in selective oscillation of only the beam having the wavelength with the maximum gain. An adjustment for dispersing the plurality of beams in the laser medium can be performed by appropriately selecting the number of lines of the diffraction grating 2. The laser device 10 can prevent the phenomenon in which oscillations of beams having different wavelengths from one another compete with one another due to the beams overlapping in the laser medium, and can efficiently oscillate a plurality of beams. As a result, the laser device 10 can achieve high efficiency and high output.

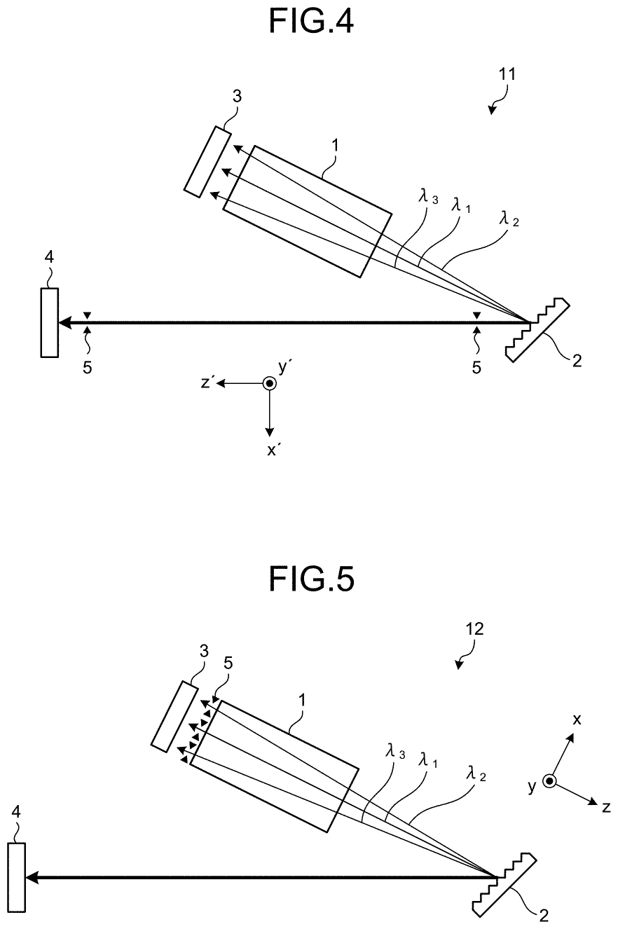

Next, a variation of the laser device 10 according to the first embodiment will be described. FIG. 4 is a diagram illustrating a schematic configuration of a laser device 11 according to a first variation of the first embodiment. The first variation is an example in which at least one aperture 5 is provided between the diffraction grating 2 and the second mirror 4. The laser device 11 has a configuration similar to that of the laser device 10 illustrated in FIG. 1 except that the aperture 5 is provided. The aperture 5 is an adjustment unit that collectively adjusts the transverse mode of a plurality of beams.

The aperture 5 allows a part of incident light to pass therethrough and at the same time restricts passage of a part of the incident light. The laser device 11 illustrated in FIG. 4 is provided with two apertures 5. The two apertures 5 are provided in a beam propagation path between the diffraction grating 2 and the second mirror 4.

In FIG. 4, an x′-axis, a y′-axis, and a z′-axis are set as three axes perpendicular to one another. The z′-axis represents the optical axis between the diffraction grating 2 and the second mirror 4. The second mirror 4 and the diffraction grating 2 are disposed on the z′-axis. The aperture 5 performs an adjustment of putting together the beam central axes of a plurality of beams into one by preventing or reducing a deviation of the beams in the x′-axis direction and the y′-axis direction. The aperture 5 also limits the transverse mode of the beams. The laser device 11 provided with the aperture 5 can oscillate a plurality of beams by putting together the beam central axes of the beams into one and adjusting the transverse mode of the beams.

The shape and diameter of the aperture 5 in the x′-axis direction and the y′-axis direction can be set as appropriate depending on the transverse mode of the beam to be oscillated. For example, a circular aperture 5 is used to oscillate a beam having a transverse mode of Transverse Electro Magnetic (TEM)₀₀. When there is a significant difference between the beam diameter in the x′-axis direction and the beam diameter in the y′-axis direction at the position where the aperture 5 is located, the aperture 5 may have a shape in which the width in the x′-axis direction is different from the width in the y′-axis direction such as an ellipse.

Instead of the aperture 5, the laser device 11 may be provided with a slit that is an adjustment unit for adjusting the transverse mode of a plurality of beams. The laser device 11 may be provided with a slit for adjusting the transverse mode in the x′-axis direction and a slit for adjusting the transverse mode in the y′-axis direction. The laser device 11 provided with the two slits can adjust the transverse mode of the beams.

FIG. 5 is a diagram illustrating a schematic configuration of a laser device 12 according to a second variation of the first embodiment. The second variation is an example in which the aperture 5 is provided for each beam between the housing unit 1 and the first mirror 3. The laser device 12 has a configuration common to that of the laser device 10 illustrated in FIG. 1 except that the aperture 5 is provided. The aperture 5 is an adjustment unit that adjusts the transverse mode of a plurality of beams for each beam.

The laser device 12 is provided with the aperture 5 for each beam dispersed by the diffraction grating 2 to be able to use the aperture 5 in which the diameter optimized for the wavelength of each beam is set. The laser device 12 can perform an adjustment for putting together the beam central axes into one and an adjustment of the transverse mode for each beam by each aperture 5. The laser device 12 can also adjust the intensity of each beam by adjusting the diameter of each aperture 5. The laser device 12 can equalize the intensity of the beams by adjusting the intensity of each beam.

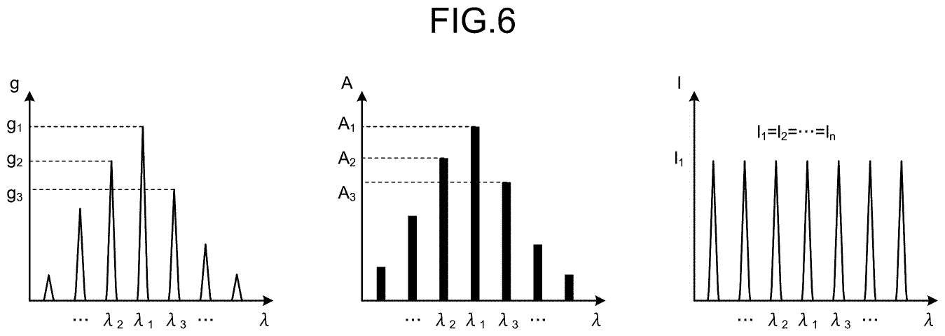

FIG. 6 is a set of graphs for explaining equalization of the intensity of the beams in the laser device 12 illustrated in FIG. 5. FIG. 6 illustrates a gain spectrum representing a relationship between the wavelength “λ” and the gain “g”, a loss spectrum representing the loss caused by each aperture 5 for each beam in the form of a relationship between the wavelength “λ” and the loss “A”, and an intensity spectrum representing a relationship between the wavelength “λ” and the beam intensity “I”.

The loss “A” due to each aperture 5 is set such that the higher the level of the gain “g” at the peak of the gain spectrum, the larger the loss “A”. In the example illustrated in FIG. 6, the maximum loss A₁ among the losses “A” due to the apertures 5 is set for a beam having the wavelength λ₁ with the maximum gain g₁. For each beam other other than the beam having the wavelength λ₁, the loss “A” is also set such that the higher the level of the gain “g” at the peak, the larger the loss “A”. The intensity of the beams is equalized by setting the loss such that the higher the peak of the gain “g” of the beam, the larger the loss due to the aperture 5, and the lower the peak of the gain “g” of the beam, the smaller the loss due to the aperture 5.

Assuming that λₙ represents an arbitrary wavelength among the wavelengths of a plurality of beams and gₙ represents the gain of the beam having the wavelength λₙ, a loss Aₙ due to the aperture 5 for the beam having the wavelength λₙ satisfies the following formula (1). The character “n” is an integer of 2 or more. In formula (1), “L” is the length of the housing unit 1 in the z-axis direction. Note that the length of the housing unit 1 does not refer to the length of the appearance of the housing unit 1, but the length of a solid formed by surfaces enclosing the space for exciting the laser medium.

(1−Aₙ)²=(1−A₁)²exp(2(g₁−gₙ)L) (1)

When the beam having the wavelength λₙ is a beam having the transverse mode of TEM₀₀ and ωₙ represents the 1/e² radius of the beam, the loss Aₙ satisfies the following formula (2). In formula (2), φₙ is the diameter of the aperture 5 for the beam having the wavelength λₙ.

Aₙ=exp(−2φₙ²/ωₙ²) (2)

The laser device 12 provided with the aperture 5 satisfying the above formulas (1) and (2) for each beam can equalize the intensity of the beams. Note that instead of the aperture 5, the laser device 12 may be provided with a slit that is an adjustment unit for adjusting the transverse mode. The laser device 12 may be provided with a slit for adjusting the transverse mode in the x-axis direction and a slit for adjusting the transverse mode in the y-axis direction for each beam.

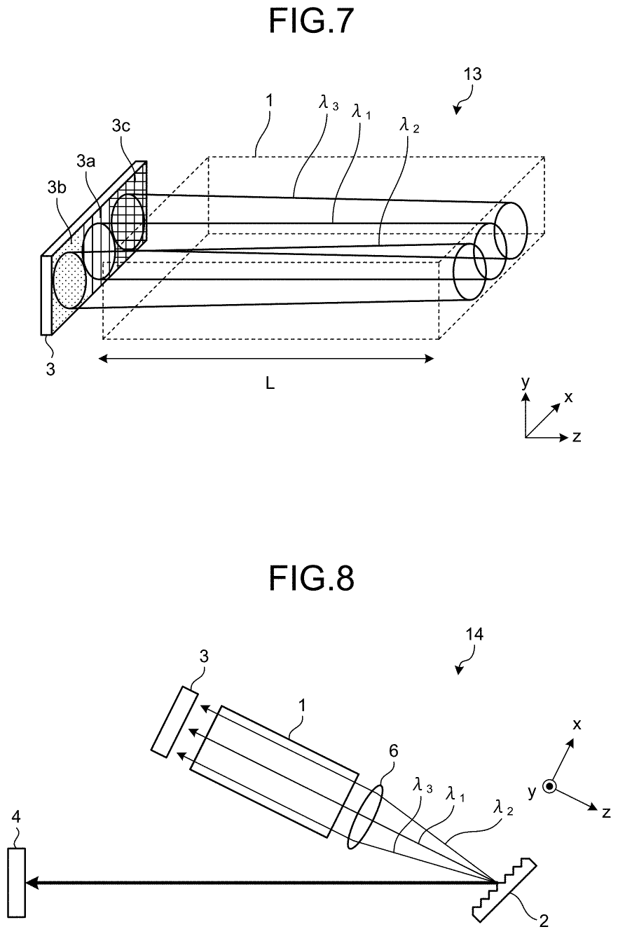

FIG. 7 is a diagram illustrating a schematic configuration of a laser device 13 according to a third variation of the first embodiment. The third variation is an example in which the first mirror 3 includes a reflecting surface with a different reflectance for each region where a beam is incident. The laser device 13 has a configuration common to that of the laser device 10 illustrated in FIG. 1 except that the first mirror 3 includes such a reflecting surface. Note that FIG. 7 omits the illustration of the components of the laser device 13 other than the housing unit 1 and the first mirror 3.

Beams dispersed by the diffraction grating 2 are incident on different regions of the reflecting surface of the first mirror 3. Note that FIG. 7 illustrates three beams having the wavelengths λ₁, λ₂, and λ₃ among the plurality of beams, and illustrates a portion of the first mirror 3 where the three beams are incident. The beam having the wavelength λ₁ is incident on a region 3a of the reflecting surface. The beam having the wavelength λ₂ is incident on a region 3b of the reflecting surface. The beam having the wavelength λ₃ is incident on a region 3c of the reflecting surface.

The reflectance of each region of the reflecting surface where the beam is incident is set such that the region where the beam having a higher level of the gain “g” at the peak of the gain spectrum is incident has a lower reflectance. The lowest reflectance r₁ among the reflectances of the regions where the beams are incident is set in the region 3a where the beam having the wavelength λ₁ with the maximum gain g₁ is incident in the example illustrated in FIG. 2. The reflectance of each region of the reflecting surface other than the region 3a is also set such that the region where the laser having a higher level of the gain “g” at the peak is incident has a lower reflectance. The intensity of the beams is equalized by setting the reflectance such that the higher the peak of the gain “g” of the beam, the lower the reflectance of the first mirror 3, and the lower the peak of the gain “g” of the beam, the higher the reflectance of the first mirror 3.

Assuming that λₙ represents an arbitrary wavelength among the wavelengths of a plurality of beams and gₙ represents the gain of the beam having the wavelength λₙ, a reflectance rₙ in a region of the first mirror 3 where the beam having the wavelength λₙ is incident satisfies the following formula (3). The character “n” is an integer of 2 or more. The character “L” is the length of the housing unit 1 in the z-axis direction.

rₙ=rᵢexp{2(g₁−gₙ)L} (3)

The laser device 13 can equalize the intensity of the beams when the reflectance of the region of the reflecting surface of the first mirror 3 where each beam is incident satisfies the above formula (3).

When the reflecting surface of the first mirror 3 is a concave surface, the radius of curvature of the concave surface in a cross section of the first mirror 3 may be equal to the distance between the diffraction grating 2 and the first mirror 3. As a result, each beam dispersed from the diffraction grating 2 toward the first mirror 3 is reflected by the first mirror 3 and then superimposed again by the diffraction grating 2.

When a first direction and a second direction are directions perpendicular to each other, the reflecting surface of the first mirror 3 may be a cylindrical surface that has a curve in the first direction and does not have a curve in the second direction. In this case, the radius of curvature of the cylindrical surface in a cross section including the first direction of the first mirror 3 may be equal to the distance between the diffraction grating 2 and the first mirror 3.

The reflecting surface of the first mirror 3 may be a toroidal surface. In this case, the radius of curvature of the cylindrical surface in a cross section including the first direction of the first mirror 3 may be equal to the distance between the diffraction grating 2 and the first mirror 3. The curvature of the cylindrical surface in a cross section including the second direction of the first mirror 3 corresponds to the curvature that allows the mirror to function as a resonance mirror. The curvature that allows the mirror to function as a resonance mirror is the curvature that allows the incident position of the light in the resonance mirror to be fixed and the wave front to be regular.

FIG. 8 is a diagram illustrating a schematic configuration of a laser device 14 according to a fourth variation of the first embodiment. The fourth variation is an example in which a convex lens 6 is provided between the diffraction grating 2 and the housing unit 1. The laser device 14 has a configuration common to that of the laser device 10 illustrated in FIG. 1 except that the convex lens 6 is provided.

The convex lens 6 is an optical element that parallelizes a plurality of beams dispersed and propagating from the diffraction grating 2 to travel toward the housing unit 1, and causes the plurality of beams propagating in the directions parallel to each other from the housing unit 1 to converge on the diffraction grating 2. Assuming that the reflecting surface of the first mirror 3 is a plane perpendicular to the z-axis, the distance between the convex lens 6 and the diffraction grating 2 is equal to the focal length of the convex lens 6. As a result, the laser device 14 can cause a plurality of beams from the first mirror 3 to converge on the diffraction grating 2 and at the same time cause the beam central axes of the plurality of beams from the diffraction grating 2 toward the first mirror 3 to be in parallel with each other. The plurality of beams parallelized by the convex lens 6 are reflected by the first mirror 3 to be incident on the convex lens 6 in the state where the beam central axes are parallel to each other. The plurality of beams incident on the convex lens 6 converge on the diffraction grating 2.

Note that the laser device 14 allows the plurality of beams parallelized by the convex lens 6 to travel through the housing unit 1 to be able to increase the space utilization rate of the plurality of beams in the laser medium as compared to when the plurality of beams with the directions of the beam central axes different from one another are caused to travel through the housing unit 1. Here, the space utilization rate is the ratio of the beams to the space in the housing unit 1. When the housing unit 1 has a rectangular parallelepiped shape, the space utilization rate of the housing unit 1 can be increased by parallelizing the plurality of beams and setting the size of the housing unit 1 according to the range of space in which the beams propagate. With the increased space utilization rate, the laser device 14 can convert a large portion of energy accumulated in the laser medium into the laser beam, and thus can achieve high efficiency.

The laser device 14 can prevent the plurality of beams from overlapping in the laser medium by parallelizing the beams with the convex lens 6. The laser device 14 can prevent the beams from overlapping by refracting the beams with the convex lens 6 such that the distance between the beam central axes of the beams adjacent to each other is longer than a sum of the beam radii of both of the beams. As a result, the laser device 14 can prevent competition due to overlapping of the beams having different wavelengths in the laser medium.

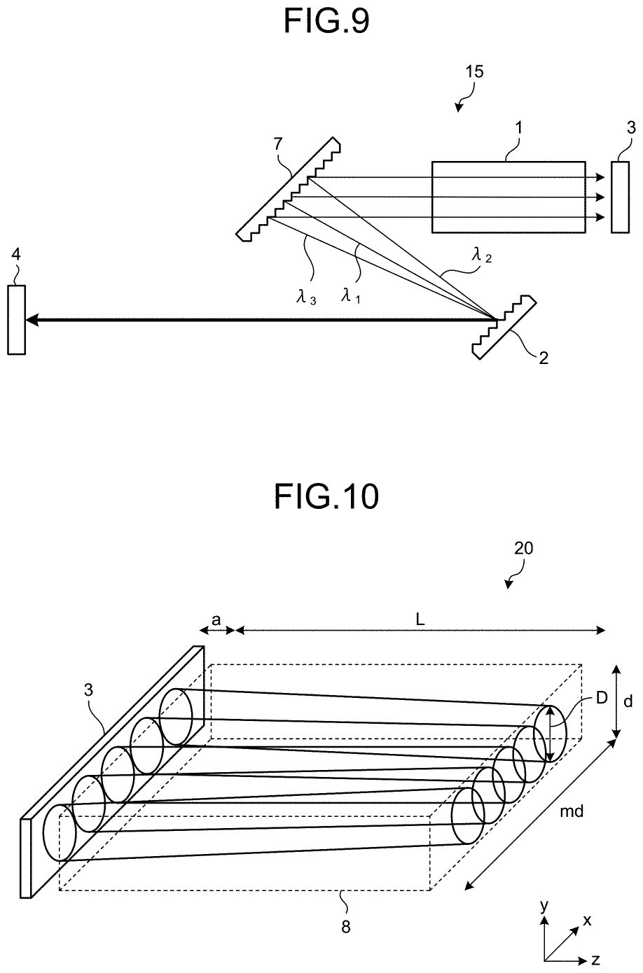

FIG. 9 is a diagram illustrating a schematic configuration of a laser device 15 according to a fifth variation of the first embodiment. The fifth variation is an example in which the diffraction grating 2 as a first diffraction grating and a diffraction grating 7 as a second diffraction grating are provided. The laser device 15 has a configuration common to that of the laser device 10 illustrated in FIG. 1 except that the diffraction grating 7 is provided.

The diffraction grating 7 parallelizes a plurality of beams dispersed and propagating from the diffraction grating 2 to travel toward the housing unit 1, and causes the plurality of beams propagating in the directions parallel to each other from the housing unit 1 to converge on the diffraction grating 2. The diffraction grating 7 has a function similar to that of the convex lens 6 described above. As a result, the laser device 14 can cause a plurality of beams from the first mirror 3 to converge on the diffraction grating 2 and at the same time cause the beam central axes of the plurality of beams from the diffraction grating 2 toward the first mirror 3 to be in parallel with each other. The plurality of beams parallelized by the diffraction grating 7 are reflected by the first mirror 3 to be incident on the diffraction grating 7 in the state where the beam central axes are parallel to each other. The plurality of beams incident on the diffraction grating 7 converge on the diffraction grating 2. Note that the diffraction grating 7 may be either a reflective diffraction grating or a transmission diffraction grating.

Note that the laser device 15 allows the plurality of beams parallelized by the diffraction grating 7 to travel through the housing unit 1 to be able to increase the space utilization rate of the plurality of beams in the laser medium, as with the fourth variation described above. When the housing unit 1 has a rectangular parallelepiped shape, the space utilization rate of the housing unit 1 can be increased by setting the size of the housing unit 1 according to the range of space in which the beams propagate. Moreover, with the plurality of beams being parallelized, the laser device 15 can prevent competition due to overlapping of the beams having different wavelengths in the laser medium. Note that the shape of the housing unit 1 does not refer to the shape of the appearance of the housing unit 1, but the shape of a solid formed by surfaces enclosing the space for exciting the laser medium.

Note that the configurations of the laser devices 11, 12, 13, 14, and 15 according to the variations of the first embodiment may be combined as appropriate in the laser device 10 described above.

### Second Embodiment

FIG. 10 is a diagram illustrating a schematic configuration of a laser device 20 according to a second embodiment of the present invention. The laser device 20 includes a housing unit 8 of a so-called slab shape having the form of a flat plate. In the second embodiment, the same components as those in the above first embodiment are denoted by the same reference numerals as those assigned to such components in the first embodiment, and a configuration different from that of the first embodiment will be mainly described.

The housing unit 8 has a shape in which the length in the x-axis direction and the length in the z-axis direction are each sufficiently longer than the length in the y-axis direction. The ratio of the lengths in the x-axis direction, the y-axis direction, and the z-axis direction may be about 10:1:100. That is, the length in the x-axis direction is about 10 times the length in the y-axis direction, and the length in the z-axis direction is about 100 times the length in the y-axis direction. The length in the z-axis direction may be longer than 100 times the length in the y-axis direction, and may be about 200 times the length in the y-axis direction. Note that the shape of the housing unit 8 does not refer to the shape of the appearance of the housing unit 8, but the shape of a solid formed by surfaces enclosing the space for exciting the laser medium. The length of the housing unit 8 refers to the length of the solid. Note that a distance “a” is the distance between the first mirror 3 and the laser medium in the housing unit 8.

When “m” beams arranged in the x-axis direction are to be passed through the housing unit 8, a length “d” of the housing unit 8 in the y-axis direction is the same as a width “D” of each beam in the y-axis direction. Here, being the same as the width “D” includes being as close as possible in length to the width “D” and being about the same as the width “D”. Also, when the length “d” is the same as the width “D”, the length of the housing unit 8 in the x-axis direction is equal to “md” which is “m” times the length “d”. The housing unit 8 thus has the form of a flat plate in which the plurality of beams arranged in the x-axis direction propagate. As a result, the laser device 20 can increase the space utilization rate in the laser medium and achieve high efficiency.

As the laser medium, the CO₂ laser gas is used as in the first embodiment. The laser device 20 in which the CO₂ laser gas is housed in the housing unit 8 of the slab shape is called a slab CO₂ laser. Since the slab CO₂ laser does not require the circulation of the CO₂ laser gas by a gas circulation device or the like, the device configuration can be reduced in size.

In the housing unit 8, the length “d” in the y-axis direction and a length “L” in the z-axis direction may satisfy the following formula (4) for the wavelength λ of each beam.

d²/(4λL)<1 (4)

A mode in the y-axis direction of each beam propagating in the laser medium in the housing unit 8 is a mode peculiar to a waveguide and is called a waveguide mode. The mode of each beam is the waveguide mode because the laser medium in the housing unit 8 takes on the function of a waveguide by satisfying the above formula (4). Therefore, the laser device 20 can reduce the coupling loss in the laser medium by increasing the coupling efficiency between the mode of each beam propagating in the resonator and the waveguide mode, and can achieve high efficiency and high output.

Next, first to fifth examples of a configuration for improving the coupling efficiency in the laser device 20 will be described. In the first to fifth examples, the laser device 20 couples the mode in the y-axis direction of each beam propagating in the resonator and the waveguide mode that is the mode in the y-axis direction of each beam in the laser medium.

FIG. 11 is a diagram illustrating the first example of the configuration for improving the coupling efficiency in the laser device 20 illustrated in FIG. 10. FIG. 11 and FIGS. 12 to 14 described later represent the configuration of the laser device 20 in which the optical axis between the diffraction grating 2 and the second mirror 4 is replaced with an extension of the optical axis between the first mirror 3 and the diffraction grating 2. The first example is an example in which the distance “a” between the first mirror 3 and the laser medium in the housing unit 8 is close to zero, and the first mirror 3 is as close as possible to the laser medium. The reflecting surface of the first mirror 3 is a flat surface. The laser device 20 can increase the coupling efficiency as well by adjusting the configuration as in the first example.

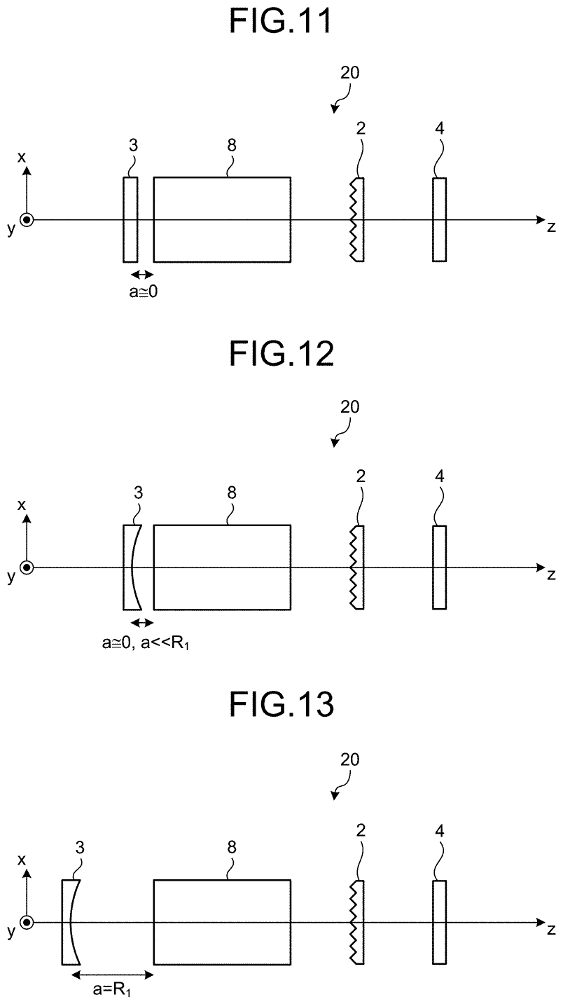

FIG. 12 is a diagram illustrating the second example of the configuration for improving the coupling efficiency in the laser device 20 illustrated in FIG. 10. The second example is an example in which the first mirror 3 is as close as possible to the laser medium as in the first example, and the reflecting surface of the first mirror 3 is a concave surface. A radius of curvature R₁ of the concave surface in a cross section parallel to the y-axis and z-axis is sufficiently larger than the distance “a”. The laser device 20 can increase the coupling efficiency as well by adjusting the configuration as in the second example.

FIG. 13 is a diagram illustrating the third example of the configuration for improving the coupling efficiency in the laser device 20 illustrated in FIG. 10. The third example is an example in which the reflecting surface of the first mirror 3 is a concave surface, and the radius of curvature R₁ is equal to the distance “a”. The laser device 20 can increase the coupling efficiency as well by adjusting the configuration as in the third example.

FIG. 14 is a diagram illustrating the fourth example of the configuration for improving the coupling efficiency in the laser device 20 illustrated in FIG. 10. The fourth example is an example in which the reflecting surface of the first mirror 3 is a concave surface, and the distance “a” is equal to half the radius of curvature R₁. The laser device 20 can increase the coupling efficiency as well by adjusting the configuration as in the fourth example.

In the laser device 20, the position of the second mirror 4 and the reflecting surface of the second mirror 4 may be adjusted as with the case where the position of the first mirror 3 and the reflecting surface of the first mirror 3 are adjusted as in the first to fourth examples. The laser device 20 can improve the coupling efficiency as well by making the adjustments for the second mirror 4 as in the case of the first mirror 3.

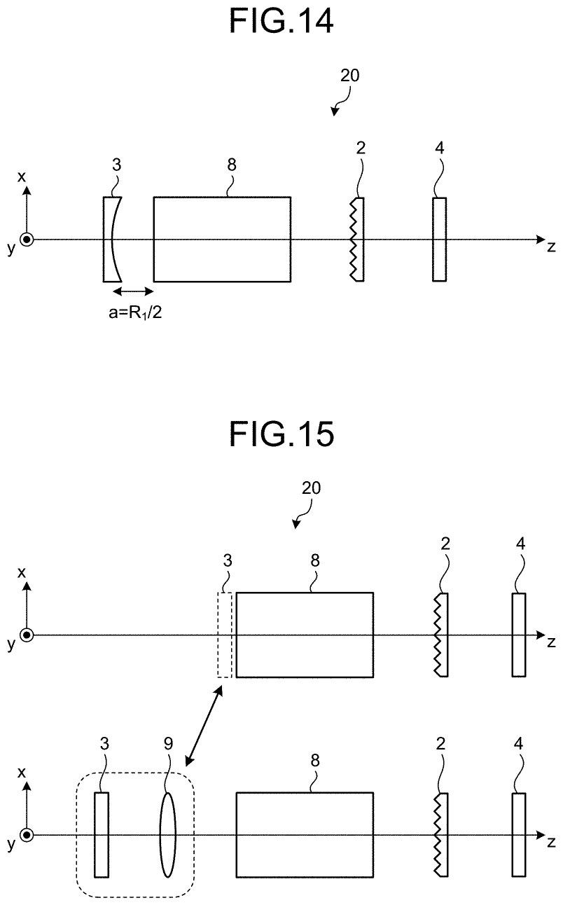

FIG. 15 is a diagram illustrating the fifth example of the configuration for improving the coupling efficiency in the laser device 20 illustrated in FIG. 10. The fifth example is an example in which a lens 9 is disposed between the housing unit 8 and the first mirror 3. The first mirror 3 includes the reflecting surface that is a flat surface. The lens 9 is an optical element that achieves optical coupling between the first mirror 3 and the laser medium. FIG. 15 also illustrates the configuration of the first example together with the configuration of the fifth example.

In the fifth example, the combination of the lens 9 and the first mirror 3 performs an optically equivalent function to the first mirror 3 in the first example. The optically equivalent function means that an ABCD matrix representing the beam propagation between the laser medium and the first mirror 3 in the first example is equal to an ABCD matrix representing the beam propagation between the laser medium and the first mirror 3 when the lens 9 is interposed therebetween in the fifth example. The laser device 20 can increase the coupling efficiency as well in the case of the fifth example. In the fifth example, the reflecting surface of the first mirror 3 is not limited to a flat surface, and may be a concave surface, a convex surface, or the like.

In the laser device 20, the lens 9 may be disposed between the housing unit 8 and the second mirror 4. In this case, the combination of the lens 9 and the second mirror 4 can perform an optically equivalent function to the second mirror 4 when the second mirror 4 is as close as possible to the laser medium. In this case as well, the laser device 20 can improve the coupling efficiency.

Note that the configuration of the laser device 20 may be combined as appropriate with the laser devices 10, 11, 12, 13, 14, and 15 according to the first embodiment. The laser devices 10, 11, 12, 13, 14, and 15 can increase the coupling efficiency by having the configuration similar to that of the laser device 20. As a result, the laser devices 10, 11, 12, 13, 14, and 15 can reduce the coupling loss in the laser medium, and can achieve high efficiency and high output.

### Third Embodiment

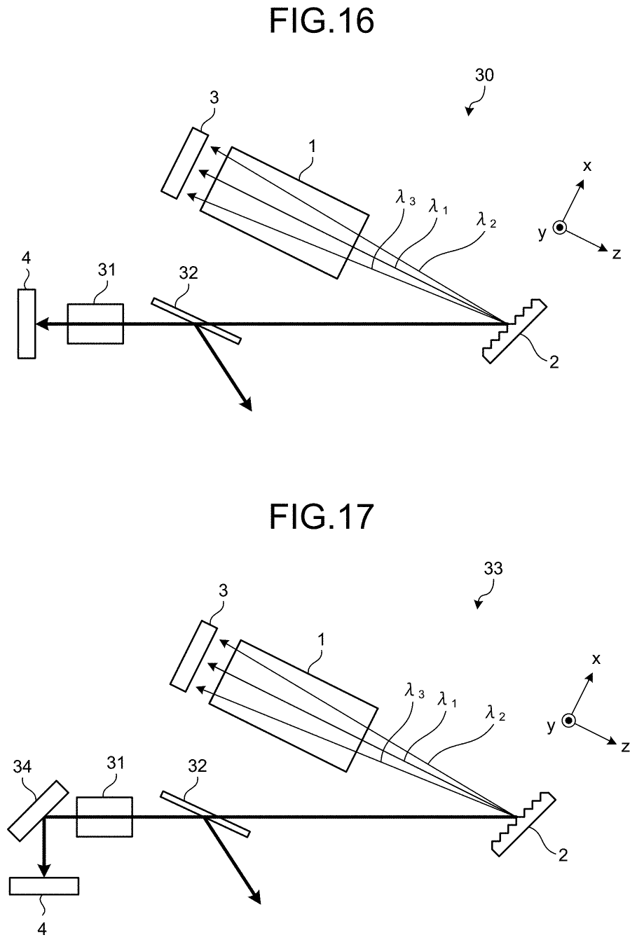

FIG. 16 is a diagram illustrating a schematic configuration of a laser device 30 according to a third embodiment of the present invention. The laser device 30 includes an electro-optic (EO) crystal 31 and a polarizing beam splitter 32. The electro-optic crystal 31 and the polarizing beam splitter 32 form a pulse oscillation mechanism. The pulse oscillation mechanism pulses a plurality of beams. In the third embodiment, the same components as those in the above first and second embodiments are denoted by the same reference numerals as those assigned to such components in the first and second embodiments, and a configuration different from that of the first and second embodiments will be mainly described.

The laser device 30 has a configuration similar to that of the laser device 10 illustrated in FIG. 1 except that the electro-optic crystal 31 and the polarizing beam splitter 32 are provided. The electro-optic crystal 31 and the polarizing beam splitter 32 are disposed between the diffraction grating 2 and the second mirror 4.

The electro-optic crystal 31 is also called a Pockels cell. The electro-optic crystal 31 changes a polarization state of light passing through the electro-optic crystal 31 by a voltage applied thereto. The polarizing beam splitter 32 has polarization characteristics of high transmittance and low reflectance for p-polarized light, and high reflectance and low transmittance for s-polarized light. The polarizing beam splitter 32 separates incident light into linearly polarized components according to such polarization characteristics.

The polarizing beam splitter 32 transmits a p-polarized component of the beam propagating between the diffraction grating 2 and the second mirror 4. Moreover, the polarizing beam splitter 32 reflects an s-polarized component of the beam propagating between the diffraction grating 2 and the second mirror 4. With the polarizing beam splitter 32 provided in the resonator, the laser device 30 causes the p-polarized component to resonate in the resonator and emits the s-polarized component to the outside of the resonator. The laser device 30 causes a loss of the beam propagating in the resonator by emitting the s-polarized component to the outside of the resonator.

The laser device 30 switches the polarization of the beam incident on the polarizing beam splitter 32 to the p-polarized light and to the s-polarized light with the switching between applying the voltage to the electro-optic crystal 31 and stopping the application of the voltage to the electro-optic crystal 31. The laser device 30 changes the loss of the beam propagating in the resonator by switching between the transmission of the p-polarized component in the polarizing beam splitter 32 and the reflection of the s-polarized component in the polarizing beam splitter 32. The laser device 30 periodically changes the beam loss as the voltage applied to the electro-optic crystal 31 is changed periodically. The laser device 30 changes the beam loss with a period of 10 kHz to 200 kHz.

Next, Q-switched oscillation, which is pulse oscillation using the pulse oscillation mechanism, will be described. Here, it is assumed that the beam loss increases when a voltage is applied to the electro-optic crystal 31, and the beam loss is minimized when no voltage is applied to the electro-optic crystal 31.

While the beam in the resonator is lost by applying a voltage to the electro-optic crystal 31, the oscillation of the beam is reduced in the laser medium so that energy is accumulated due to the excitation of molecules. When the beam loss is minimized thereafter, the laser device 30 can increase the peak output of the beam with the energy accumulated. The laser device 30 can perform pulse oscillation of a coupled beam by periodically changing the beam loss in the resonator. That is, the laser device 30 pulses a plurality of beams simultaneously and outputs a pulsed beam being the coupled beam that has been pulsed.

Next, Q-switched/cavity-dumped method, which is one method of pulsing a beam, will be described. The beam loss in the resonator is increased by applying a voltage to the electro-optic crystal 31 at a timing close to the peak of a pulse obtained by Q-switched oscillation. The laser device 30 extracts a pulsed beam, which is a pulsed coupled beam, from the polarizing beam splitter 32 instead of the second mirror 4. In this case, as the second mirror 4, a mirror that reflects each of a plurality of beams is used instead of the partially reflective mirror. A coating with a high reflectance of 99% or higher, for example, is applied to the reflecting surface of the second mirror 4.

When L_{c} is the cavity length, which is the length of a beam propagation path between the first mirror 3 and the second mirror 4, and “c” is the speed of light, the pulse width of the coupled beam extracted from the polarizing beam splitter 32 is equal to 2L_{c}/c. As a result, the laser device 30 can not only pulse the plurality of beams simultaneously, but also extract the pulsed beam having the pulse width corresponding to the cavity length.

Note that for the pulse oscillation mechanism of the laser device 30, a thin film polarizer or the like may be used instead of the polarizing beam splitter 32, the thin film polarizer being an optical element having a function similar to that of the polarizing beam splitter 32. The pulse oscillation mechanism may be disposed between the diffraction grating 2 and the housing unit 1 other than being disposed between the diffraction grating 2 and the second mirror 4. In this case as well, the laser device 30 can output a pulsed beam.

Next, a variation of the laser device 30 according to the third embodiment will be described. FIG. 17 is a diagram illustrating a schematic configuration of a laser device 33 according to a first variation of the third embodiment. The first variation is an example in which a circular polarization mirror 34 is provided. The laser device 33 has a configuration similar to that of the laser device 30 illustrated in FIG. 16 except that the circular polarization mirror 34 is provided.

The laser device 33 is provided with the circular polarization mirror 34 in addition to the pulse oscillation mechanism for performing Q-switched oscillation, the circular polarization mirror 34 being provided in a beam propagation path between the electro-optic crystal 31 and the second mirror 4. The circular polarization mirror 34 converts linearly polarized light into circularly polarized light. Here, it is assumed that the beam loss is minimized when a voltage is applied to the electro-optic crystal 31, and the beam loss increases when the application of the voltage to the electro-optic crystal 31 is stopped.

The laser device 33 can accumulate more energy in the laser medium as the beam is lost for a longer period of time, and can obtain a pulsed beam having a high-level peak and a short pulse width. When the beam is lost by applying the voltage to the electro-optic crystal 31, the prolongation of the period for which the voltage is applied to the electro-optic crystal 31 in order to obtain such a pulsed beam is likely to cause deterioration or failure of the electro-optic crystal 31 and a driver for applying the voltage.

A voltage called a quarter-wave voltage is generally applied to the electro-optic crystal 31. When the voltage is applied to the electro-optic crystal 31, the beam reciprocating in the resonator and passing through the electro-optic crystal 31 twice causes the polarization direction of the linearly polarized light of the beam to be rotated by 90 degrees. Moreover, in the first variation, the beam reciprocating between the electro-optic crystal 31 and the second mirror 4 and being reflected twice by the circular polarization mirror 34 causes the polarization direction of the linearly polarized light to be rotated by 90 degrees. When the voltage is applied to the electro-optic crystal 31, the p-polarized light transmitted through the polarizing beam splitter 32 and propagating toward the second mirror 4 is p-polarized by the conversion of the polarization state in the electro-optic crystal 31 and the conversion of the polarization state in the circular polarization mirror 34 while reciprocating between the polarizing beam splitter 32 and the second mirror 4. The p-polarized component incident on the polarizing beam splitter 32 is transmitted through the polarizing beam splitter 32. In this case, the laser device 33 has less beam loss from the resonator by the reduced emission of the s-polarized component to the outside of the resonator. On the other hand, when the application of the voltage to the electro-optic crystal 31 is stopped, the p-polarized light transmitted through the polarizing beam splitter 32 is s-polarized by the conversion of the polarization state in the circular polarization mirror 34 while reciprocating between the polarizing beam splitter 32 and the second mirror 4. The s-polarized component incident on the polarizing beam splitter 32 is reflected by the polarizing beam splitter 32. In this case, the laser device 33 has more beam loss from the resonator by the increased emission of the s-polarized component to the outside of the resonator.

As described above, the laser device 33 is provided with the circular polarization mirror 34 to be able to lose the beam when no voltage is applied to the electro-optic crystal 31. Thus, in order to obtain a pulsed beam having a high-level peak and a short pulse width, it is sufficient to stop the application of the voltage to the electro-optic crystal 31, so that the laser device 33 can prevent deterioration and failure of the electro-optic crystal 31 and the driver for applying the voltage. Note that the laser device 33 may be provided with a quarter-wave plate instead of the circular polarization mirror 34. In this case as well, the laser device 33 can be configured to lose the beam when no voltage is applied to the electro-optic crystal 31.

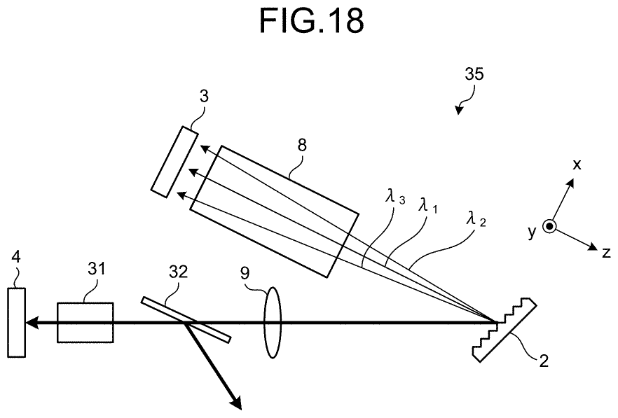

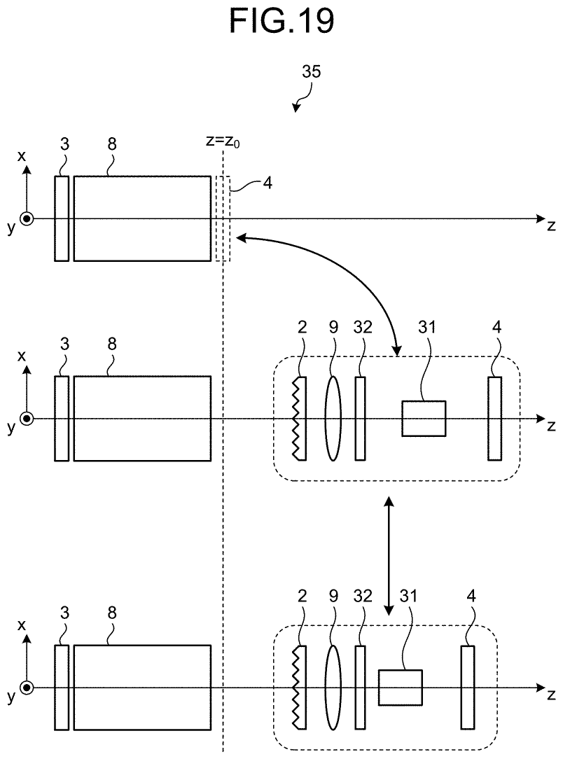

FIG. 18 is a diagram illustrating a schematic configuration of a laser device 35 according to a second variation of the third embodiment. The second variation is an example in which the lens 9 and the housing unit 8 similar to that of the second embodiment are provided. The laser device 35 has a configuration similar to that of the laser device 30 illustrated in FIG. 16 except that the lens 9 is provided and the housing unit 8 is provided in place of the housing unit 1.

As the intensity of the beam propagating in the resonator increases, the temperature of the optical element such as the electro-optic crystal 31 provided in the beam propagation path rises by absorbing the beam. The optical element whose temperature has risen may cause a thermal lens effect due to a change in density or a change in refractive index caused by the rise in temperature, for example. Since the focal length of the optical element causing the thermal lens effect changes with temperature, the thermal lens effect can be a factor in reducing the coupling efficiency between the mode of each beam propagating in the resonator and the waveguide mode.

The lens 9 is provided in the beam propagation path between the diffraction grating 2 and the polarizing beam splitter 32. The lens 9 has a function of canceling the thermal lens effect by the optical element provided in the beam propagation path. With the provision of the lens 9, the laser device 35 can prevent a reduction in the coupling efficiency due to the thermal lens effect, and can improve the coupling efficiency. Note that the lens 9 can be disposed at an arbitrary position of the beam propagation path in the resonator. The laser device 35 can effectively improve the coupling efficiency by the lens 9 disposed at an appropriate position.

FIG. 19 is a diagram explaining a configuration for improving the coupling efficiency in the laser device 35 illustrated in FIG. 18. FIG. 19 illustrates the configuration of the laser device 35 and a basic configuration of the resonator extracted from the laser device 35. Below such a basic configuration, the configuration of the laser device 35 illustrated in FIG. 18 is illustrated. The bottom of FIG. 19 illustrates a state in which the thermal lens effect is caused by the electro-optic crystal 31 in the laser device 35 illustrated in FIG. 18. Note that FIG. 19 represents the configuration of the laser device 35 in which the optical axis between the diffraction grating 2 and the second mirror 4 is replaced with an extension of the optical axis between the first mirror 3 and the diffraction grating 2.

In the basic configuration of the resonator, the first mirror 3 and the second mirror 4 are disposed as close as possible to the laser medium in the housing unit 8. In this basic configuration, the coupling efficiency can be increased by making each of the reflecting surface of the first mirror 3 and the reflecting surface of the second mirror 4 a flat surface, for example. The second mirror 4 is disposed at the position of z=z₀. The laser device 35 is provided with a combination of the diffraction grating 2, the lens 9, the polarizing beam splitter 32, the electro-optic crystal 31, and the second mirror 4 in place of the second mirror 4 in the above basic configuration. The lens 9 is an optical element that achieves optical coupling between the second mirror 4 and the laser medium. Note that the propagation of light in the polarizing beam splitter 32 is considered to be equivalent to the propagation of light in free space, and thus the beam propagation in the polarizing beam splitter 32 will not be described in the following description. It is also assumed that the laser device 35 couples the mode in the y-axis direction of each beam propagating in the resonator and the waveguide mode that is the mode in the y-axis direction of each beam in the laser medium. Since the mode in the y-axis direction of each beam in the laser medium is the waveguide mode for the sake of explanation, the ABCD matrix of the diffraction grating 2 may be regarded as the unit matrix.

The combination of the diffraction grating 2, the lens 9, the electro-optic crystal 31, and the second mirror 4 is configured to perform the optically equivalent function to the second mirror 4 disposed at z=z₀, whereby the laser device 35 can increase the coupling efficiency. Note that the optically equivalent function means that the ABCD matrix representing the beam propagation between the second mirror 4 disposed at the position of z=z₀ and the laser medium is equal to the ABCD matrix representing the beam propagation between the laser medium and the second mirror 4 when the diffraction grating 2, the lens 9, and the electro-optic crystal 31 are interposed between the laser medium and the second mirror 4. However, when the thermal lens effect is caused by the temperature rise of the electro-optic crystal 31 being the optical element included in the combination, the combination can no longer perform the optically equivalent function to the second mirror 4 disposed at the position of z=z₀. Note that the reflecting surface of the second mirror 4 included in the combination is not limited to a flat surface, and may be a concave surface, a convex surface, or the like.

The laser device 35 adjusts the positional relationship of the components included in the combination such that, when the thermal lens effect occurs, the combination can perform the optically equivalent function to the second mirror 4 disposed at the position of z=z₀. The ABCD matrix of the electro-optic crystal 31 producing the thermal lens effect may be, for example, the ABCD matrix identical to that of a thin lens having the focal length equivalent to that of the thermal lens. The laser device 35 can cancel the thermal lens effect by adjusting the positional relationship of the components in the combination. As a result, the laser device 35 can make the optical function of the combination equivalent to the optical function of the second mirror 4 in the above basic configuration.

Note that the laser device 35 can make the optical function of the combination equivalent to that of the basic configuration by adjusting the position of at least one of the components in the combination. The laser device 35 can maintain high coupling efficiency by adjusting the optical function of the combination to be equivalent to that of the above basic configuration.

Note that the configuration of each of the laser devices 30, 33, and 35 may be combined as appropriate with the laser device according to each of the first and second embodiments. The laser device according to each of the first and second embodiments can output a pulsed beam, which is a pulsed coupled beam, and effectively improve the coupling efficiency by having the configuration similar to that of the laser devices 30, 33, and 35.

### Fourth Embodiment

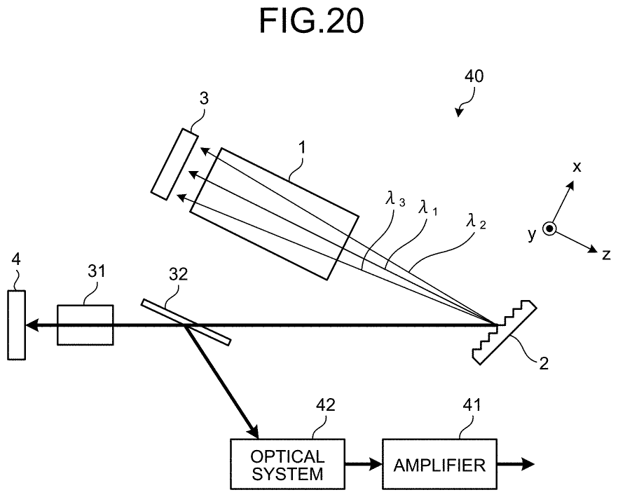

FIG. 20 is a diagram illustrating a schematic configuration of a laser device 40 according to a fourth embodiment of the present invention. The laser device 40 includes at least one amplifier 41 and an optical system 42 through which a beam propagates toward the amplifier 41. In the fourth embodiment, the same components as those in the above first to third embodiments are denoted by the same reference numerals as those assigned to such components in the first to third embodiments, and a configuration different from that of the first to third embodiments will be mainly described.

The laser device 40 has a configuration similar to that of the laser device 30 illustrated in FIG. 16 except that the amplifier 41 and the optical system 42 are provided. A pulsed beam extracted outside the resonator from the polarizing beam splitter 32 propagates through the optical system 42 and enters the amplifier 41. The amplifier 41 amplifies the pulsed beam extracted from the resonator. The laser device 40 outputs the pulsed beam amplified by the amplifier 41. The laser device 40 can thus achieve high output. Note that the number of the amplifiers 41 provided in the laser device 40 may be one or more. The laser device 40 is not limited to the one that outputs the pulsed beam extracted from the polarizing beam splitter 32, and may be one that outputs the pulsed beam emitted from the second mirror 4. The amplifier 41 may amplify the pulsed beam emitted from the second mirror 4.

The laser device 40 extracts the pulsed beam, which is a pulsed coupled beam, from the polarizing beam splitter 32 instead of the second mirror 4. The pulsed beam extracted is incident on the optical system 42. In this case, as the second mirror 4, a mirror that reflects each of a plurality of beams is used instead of the partially reflective mirror. A coating with a high reflectance of 99% or higher, for example, is applied to the reflecting surface of the second mirror 4.

The amplifier 41 includes a mirror that reflects a beam and an amplification medium. As the mirror, a high reflectance mirror having a reflectance of 99.9% or higher may be used. The amplification medium is a medium having a gain for each wavelength of the plurality of beams oscillated by the laser device 40. The amplifier 41 can thus amplify each beam oscillated, so that the laser device 40 can achieve high output. Note that the amplifier 41 may allow each beam to pass through the amplification medium a plurality of times by reflecting each beam using a plurality of mirrors.

As the laser medium, the CO₂ laser gas is used as in the first embodiment. For example, when the Q-switched/cavity-dumped method is used to oscillate a single beam of P (20) having a wavelength of 10.59 μm with a pulse width of 10 ns to 30 ns, the amplification efficiency of the pulsed beam by the amplifier 41 is lower than when a continuous wave of the beam of P (20) is amplified. In the fourth embodiment, the laser device 40 performs pulse oscillation of a beam of P (18) having a wavelength of 10.57 μm and a beam of P (22) having a wavelength of 10.61 μm together with the beam of P (20), and thus can prevent a decrease in the amplification efficiency as compared to the case of pulse oscillation of a single beam. As a result, the laser device 40 can achieve high output.

The laser device 40 may be, for example, a CO₂ laser used in an extreme ultra violet (EUV) light source device that outputs the pulsed beams of P (20), P (18), and P (22). The EUV light source device generates EUV light by, for example, irradiating a tin droplet with the pulsed beams of P (20), P (18), and P (22) having the pulse width of 10 ns to 30 ns. The EUV light source device can achieve high output of the EUV light by amplifying the pulsed beams in the amplifier 41 of the laser device 40.

The laser device 40 may oscillate a beam other than P (20), P (18), and P (22). As the number of beams having different wavelengths increases, the laser device 40 can prevent a decrease in the amplification efficiency and thus achieve higher output.

The configuration of the laser device 40 may be applied to each of the laser devices according to the first to third embodiments. Each of the laser devices according to the first to third embodiments can achieve high output by having the configuration similar to that of the laser device 40.

The configurations illustrated in the above embodiments merely illustrate examples of the content of the present invention, and can thus be combined with another known technique or partially omitted and/or modified without departing from the scope of the present invention.

### REFERENCE SIGNS LIST

1, 8 housing unit; 2, 7 diffraction grating; 3 first mirror; 3a, 3b, 3c region; 4 second mirror; 5 aperture; 6 convex lens; 9 lens; 10, 11, 12, 13, 14, 15, 20, 30, 33, 35, 40 laser device; 31 electro-optic crystal; 32 polarizing beam splitter; 34 circular polarization mirror; 41 amplifier; 42 optical system.

1.-13. (canceled)

14. A laser device comprising:
a first mirror and a second mirror to cause resonance of a plurality of beams having different wavelengths from one another;
a diffraction grating to cause the plurality of beams that are incident from the first mirror with directions of beam central axes being different from one another to travel to the second mirror while aligning the beam central axes with one another, and cause the plurality of beams that are incident from the second mirror with the beam central axes being aligned with one another to travel to the first mirror with the directions of the beam central axes being different from one another;
a housing housing a carbon dioxide laser gas that is a laser medium through which the plurality of beams traveling between the first mirror and the diffraction grating pass, and has a discrete gain spectrum in which a peak occurs at each wavelength of the plurality of beams; and
an adjuster provided between the diffraction grating and the first mirror to adjust a loss of the plurality of beams for each beam, wherein
the plurality of beams are output with the beam central axes being aligned with one another, and beam intensity of the plurality of beams is equalized.

15. A laser device comprising:
a first mirror and a second mirror to cause resonance of a plurality of beams having different wavelengths from one another;
a diffraction grating to cause the plurality of beams that are incident from the first mirror with directions of beam central axes being different from one another to travel to the second mirror while aligning the beam central axes with one another, and cause the plurality of beams that are incident from the second mirror with the beam central axes being aligned with one another to travel to the first mirror with the directions of the beam central axes being different from one another; and
a housing housing a carbon dioxide laser gas that is a laser medium through which the plurality of beams traveling between the first mirror and the diffraction grating pass, and has a discrete gain spectrum in which a peak occurs at each wavelength of the plurality of beams, wherein
the plurality of beams are output with the beam central axes being aligned with one another, and
the first mirror includes a reflecting surface having a reflectance different for each region on which a corresponding one of the plurality of beams is incident, and equalizes beam intensity of the plurality of beams.

16. The laser device according to claim 14, wherein a pulse oscillation mechanism is provided between the diffraction grating and the second mirror, and the plurality of beams are pulsed by at least one of Q-switched oscillation and Q-switched/cavity-dumped oscillation.

17. The laser device according to claim 15, wherein a pulse oscillation mechanism is provided between the diffraction grating and the second mirror, and the plurality of beams are pulsed by at least one of Q-switched oscillation and Q-switched/cavity-dumped oscillation.

18. The laser device according to claim 16, comprising an amplifier to amplify the plurality of beams pulsed by the pulse oscillation mechanism.

19. The laser device according to claim 17, comprising an amplifier to amplify the plurality of beams pulsed by the pulse oscillation mechanism.

20. The laser device according to claim 14, wherein the first mirror includes a reflecting surface that is a concave surface, and a radius of curvature of the concave surface in a cross section of the first mirror is equal to a distance between the diffraction grating and the first mirror.

21. The laser device according to claim 15, wherein the first mirror includes a reflecting surface that is a concave surface, and a radius of curvature of the concave surface in a cross section of the first mirror is equal to a distance between the diffraction grating and the first mirror.

22. The laser device according to claim 14, comprising an optical element provided between the diffraction grating and the housing to parallelize the plurality of beams propagating from the diffraction grating and cause the plurality of beams propagating from the housing to converge.

23. The laser device according to claim 15, comprising an optical element provided between the diffraction grating and the housing to parallelize the plurality of beams propagating from the diffraction grating and cause the plurality of beams propagating from the housing to converge.

24. The laser device according to claim 14, wherein the housing has a flat plate shape.

25. The laser device according to claim 15, wherein the housing has a flat plate shape.

26. The laser device according to claim 24, comprising an optical element to achieve optical coupling between the first mirror and the laser medium.

27. The laser device according to claim 25, comprising an optical element to achieve optical coupling between the first mirror and the laser medium.

28. The laser device according to claim 24, comprising an optical element to achieve optical coupling between the second mirror and the laser medium.

29. The laser device according to claim 25, comprising an optical element to achieve optical coupling between the second mirror and the laser medium.
